(19) United States
(12) Patent Application Publication
(10) Pub. No.: US 2025/0377235 A1
(43) Pub. Date: Dec. 11, 2025

(54) Methods and Systems for Measuring and Deploying Mass transported by a Railway Vehicle

(71) Applicant: Intramotev Inc., St. Louis, MO (US)

(72) Inventors: Samuel David King, O'Fallon, IL (US); Briton Rand Bauerly, Kirkwood, MO (US); Grace Carolyn Stonner, Saint Peters, MO (US); Adam Young, University City, MO (US)

(21) Appl. No.: 18/735,823

(22) Filed: Jun. 6, 2024

(51) Int. Cl. G01G 19/04

(52) U.S. Cl. CPC G01G 19/047

(57) ABSTRACT

The disclosed technology pertains to methods and systems for measuring and deploying mass transported by railway vehicles. A computing system may receive sensor data from multiple sensors coupled to a railway vehicle as the railway vehicle moves along a track. The computing system may use the sensor data to determine acceleration data and force data corresponding to the railway vehicle as the railway vehicle moves along the track. The force data represents a quantity of force applied to the railway vehicle to cause the railway vehicle to move along the track. The computing system may then estimate, based on the acceleration data and force data for the railway vehicle, a mass of the railway vehicle. The computing system may further use sensor data to determine that the railway vehicle is located proximate a drop zone and trigger an automatic release of cargo carried by the railway vehicle.

### FIELD

The present disclosure generally relates to railway vehicle technology, and more specifically, to methods and systems for estimating the mass of a railcar and enabling automatic or remotely-controlled deployment of cargo by the railcar at a desired location.

### BACKGROUND

Railway vehicles, such as freight trains, are a common mode of transportation for a wide range of goods and materials. In general, railway vehicles are typically designed to carry heavy loads over long distances, making them a cost-effective and efficient solution for various industries. As such, the mass of the railway vehicle, including its cargo, can have a direct impact on its performance, safety, and efficiency. Therefore, accurately estimating the mass of a railway vehicle is a task of considerable interest. In addition, there is also a need to efficiently and safely deploy materials or other types of goods carried by the railway vehicle at a desired drop location.

### SUMMARY

Example embodiments are directed to methods and systems designed for the estimation of the mass of materials or goods transported by a railway vehicle, as well as the facilitation of their automated deployment at predetermined drop locations. Using onboard sensors, the system captures relevant measurements that enable the estimation of the railway vehicle's mass as well as the identification of the precise moment when the railway vehicle reaches a designated drop zone for the automated unloading of materials or goods. In some instances, an onboard computing system may transmit data pertaining to the railway vehicle's current status, including its estimated mass and location, to a remote computing device. This allows the remote computing device or an operator using the remote device to leverage the estimated mass of the railway vehicle to optimize its performance and to oversee or direct the unloading of materials or goods at the specified drop location.

Accordingly, an example embodiment describes a method. The method involves receiving, at a computing system, sensor data from a plurality of sensors coupled to a railway vehicle as the railway vehicle moves along a track and determining, based on the sensor data, acceleration data and force data corresponding to the railway vehicle as the railway vehicle moves along the track. The force data represents a quantity of force applied to the railway vehicle to cause the railway vehicle to move along the track. The method further involves estimating, based on the acceleration data and force data for the railway vehicle, a mass of the railway vehicle.

Another example embodiment describes a system. The system includes a computing device coupled to a railway vehicle. The computing device is configured to receive sensor data from a plurality of sensors coupled to the railway vehicle as the railway vehicle moves along a track and to determine, based on the sensor data, acceleration data and force data corresponding to the railway vehicle as the railway vehicle moves along the track. The force data represents a quantity of force applied to the railway vehicle to cause the railway vehicle to move along the track. The computing device is further configured to estimate, based on the acceleration data and force data for the railway vehicle, a mass of the railway vehicle.

A further example embodiment describes a non-transitory computer readable medium. The non-transitory computer-readable medium is configured to store instructions, that when executed by a computing system comprising one or more processors, causes the computing system to perform operations. The operations involve receiving sensor data from a plurality of sensors coupled to the railway vehicle as the railway vehicle moves along a track and determining, based on the sensor data, acceleration data and force data corresponding to the railway vehicle as the railway vehicle moves along the track. The force data represents a quantity of force applied to the railway vehicle to cause the railway vehicle to move along the track. The operations also involve estimating, based on the acceleration data and force data for the railway vehicle, a mass of the railway vehicle.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 is a functional block diagram illustrating a motive system for a railway vehicle, according to one or more example embodiments.

FIG. 2 is a functional block diagram illustrating a computing system, according to one or more example embodiments.

FIG. 3 is a configuration of a railway vehicle with a motive system, according to one or more example embodiments.

FIG. 4 is another configuration of a railway vehicle with a motive system, according to one or more example embodiments.

FIG. 5 is an additional configuration of a railway vehicle with a motive system, according to one or more example embodiments.

FIG. 6 is a functional block diagram illustrating a system for estimating the mass of a railway vehicle and enabling automatic deployment of cargo carried by the railway vehicle, according to one or more example embodiments.

FIG. 7 is a flowchart of a method for estimating the mass of a railway vehicle, according to one or more example embodiments.

FIG. 8 is a flowchart of a method for the automatic deployment of cargo carried by a railway vehicle, according to one or more example embodiments.

FIG. 9 is a block diagram of a system for enabling automatic or remote dumping of materials transported by a railway vehicle, according to one or more example embodiments.

FIG. 10 is a block diagram of a railcar dump system, according to one or more example embodiments.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The present disclosure relates to systems and methods for estimating the mass of a railway vehicle and enabling automatic deployment of the railway vehicle's cargo at desired destinations. In some aspects, a system may include a variety of sensors coupled to the railway vehicle, a computing system for processing sensor data output by the sensors, and one or more motors attached to the railway vehicle for propelling the railway vehicle along a track. The system can be implemented as part of the original design for the railway vehicle and/or can be retrofitted onto an existing railway vehicle (e.g., a freight car). The sensors included as part of the system may include, but are not limited to, inertial measurement units (IMUs), torque sensors, and/or other types of sensors that can measure information about the state of the railway vehicle, such as the acceleration and force applied to the railway vehicle. The computing system, which can consist of one or more computing devices located onboard the railway vehicle, may process the sensor data to estimate the mass of the vehicle, which can then be used to determine the weight of cargo being carried by the railway vehicle and/or to modify the control strategy for the railway vehicle.

In some cases, the computing system may use the sensor data from the sensors to generate a profile for the railway vehicle, which represents the acceleration of the railway vehicle and the force applied to the railway vehicle during movement along a track. The generated profile can be used to estimate the mass of the railway vehicle and convey information to operators and/or other computing systems. For instance, the generated profile can identify and provide information about the railway vehicle, including its current location and the route the railway vehicle is traveling, operational parameters (e.g., speed and acceleration), total mass of the railway vehicle, and/or mass of cargo being carried by the railway vehicle. The generated profile can be distributed to operators that monitor aspects of the rail network being used by the railway vehicle as well as other parties that have an interest in the railway vehicle (e.g., the operator of the target destination for the railway vehicle).

In some examples, the system may also include a dump subsystem, which is designed to enable the automatic deployment of materials and/or other types of cargo carried by the railway vehicle. In some cases, the dump subsystem is controlled by an onboard computing system that uses sensor data to pinpoint when the railway vehicle is located at the drop zone. This process can be performed in an autonomous manner without reliance on operator input. For instance, the sensor measurements can inform a control system that the railway vehicle is positioned at the desired drop zone and responsively trigger the dump subsystem to deploy the carried cargo. In other cases, the dump subsystem may be actuated based on commands received from a remote computing device. For example, the onboard system may communicate a signal to the remote computing device that indicates the railway vehicle is approaching or positioned at the drop zone, which may then enable the remote computing device to approve the deployment of cargo carried by the railway vehicle at the drop zone. The remote computing device may generate a natural language question that enables an operator to review and approve the deployment at the drop zone. For instance, the natural language can specify that the railway vehicle is located at the drop zone and request approval to initiate deployment from the operator who is reviewing the situation.

The configuration of the dump subsystem may differ within examples. In addition, the dump subsystem may depend on the configuration of the railway vehicle. In some examples, the dump subsystem may include an electric solenoid or other actuation mechanisms for releasing the materials or other type of cargo. In particular, an electric solenoid is a type of electromechanical device that converts electrical energy into mechanical motion and may consist of a coil of wire (the solenoid) and a movable metal core or plunger that is positioned inside the coil. When an electric current passes through the coil, it creates a magnetic field that exerts a force on the plunger, causing the plunger to move. The movement of the plunger can be used to actuate a mechanical process, such as opening or closing a valve, moving a lever, or triggering a release mechanism. As such, the dump subsystem may use one or multiple solenoids to trigger the deployment of the goods from the railway vehicle and to also close the release mechanics to enable subsequent travel by the railway vehicle.

The systems and methods described herein offer numerous advantages, such as the ability to precisely estimate the mass of a railway vehicle, which can be used to determine the weight of the cargo being transported. This may negate dependency on traditional weighing stations and also eliminate the downtime associated with stationary weight assessments. Accurate mass estimations, which can be derived from control systems located either on the railway vehicle or remotely, can enhance the efficiency of cargo transport and help mitigate the risks associated with overloading. Furthermore, precise knowledge of the cargo's weight is useful for the safety and operational efficiency of rail transport, as overloading can lead to mechanical breakdowns, track damage, or even derailments, while underloading may result in suboptimal utilization of capacity. Proper weight distribution is also a factor that can affect the dynamics of a train, influencing its acceleration, braking, and handling characteristics, which in turn can impact maintenance schedules and the durability of railway infrastructure. Compliance with weight regulations is often compulsory to avoid fines and maintain the integrity of the rail network.

From a financial and operational standpoint, accurate weight determinations can be valuable for managing costs, especially since freight charges often correlate with weight, and for enhancing fuel efficiency. The data pertaining to weight can further aid in logistical planning, encompassing route planning, scheduling, and the allocation of resources, thereby promoting a seamless and cost-effective rail system operation. In addition, in the aftermath of an incident, the weight of the cargo becomes a critical piece of information for emergency response teams. Efficient loading procedures, guided by precise weight information, can also diminish the number of trips and the environmental footprint of rail transportation. The automation of cargo deployment can expedite the unloading process, curtailing the time and manpower requirements. The integration of remote control capabilities and sensor-based positioning further augments the accuracy and safety of deploying materials and cargo.

In some aspects, an example method involves receiving sensor data from sensors coupled to a railway vehicle as the railway vehicle moves along a track. The sensors may be strategically positioned on the railway vehicle to capture relevant data. For instance, the sensors may be positioned on the chassis, the wheelsets, and/or other parts of the railway vehicle. In some cases, the sensors and other components of the system may be part of the railway vehicle design. In other cases, the sensors and other components can be retrofitted onto an existing railway vehicle, such as onto older freight cars. As such, the sensors may include, but are not limited to, accelerometers, gyroscopes, Inertial Measurement Units (IMUs), cameras, Light Detection and Ranging (LiDAR), radar, torque sensors, wheel slip sensors, Global Navigation Satellite System (GNSS) receivers, strain gauges, and pressure sensors, among others. The sensor data output by the sensors may provide various information about the position and state of the railway vehicle, including the acceleration of the railway vehicle, the force applied to the railway vehicle, and other relevant parameters. In some cases, the force applied to the railway vehicle is determined based on measurements of the force applied to the railway vehicle by one or more motors connected to the railway vehicle.

A computing system, which may comprise one or several computing devices, is responsible for collecting, processing, and analyzing the sensor data. The computing devices can be located either on the railway vehicle itself and/or at a remote location. For example, an onboard computing system could capture data directly from sensors installed on the vehicle and swiftly relay the information to a remote computing system through wireless communication. Both the onboard and remote computing systems can work in tandem to orchestrate the operations carried out by the railway vehicle.

In some examples, the computing system may use the sensor data to generate a profile for the railway vehicle, which may represent the acceleration of the railway vehicle and the force applied to the railway vehicle during movement along the track. The profile can be distributed to a remote control system and may also be used to estimate the mass of the railway vehicle. In particular, the information represented by the profile can be used to estimate the mass of the railway vehicle, which can then be used to determine the mass of materials or other types of goods carried by the railway vehicle. The profile can also convey other information, such as the location, speed, altitude, target destination, weight of cargo being carried by the railway vehicle, and other information about the railway vehicle. A central system may obtain profiles from multiple trains as part of managing the use of the railway vehicles and railway network.

In some cases, the sensor data generated by onboard sensors may be processed using a Kalman filter and/or other suitable algorithms to improve the accuracy of the mass estimation determined based on the sensor data. The Kalman filter may be used to estimate the state of a dynamic system by minimizing the mean of the squared error. In general, a Kalman filter is useful for integrating data from multiple sensors to estimate the state of a dynamic system, such as the state of the railway vehicle. The Kalman filter can operate in two main phases: prediction and update. In the prediction phase, the filter uses a system model to forecast the next state based on the previous state and any control inputs, along with the uncertainty of that prediction. When new sensor data arrives, the filter enters the update phase, where it computes the difference between the predicted state and the actual sensor measurements, known as the residual. The Kalman filter then calculates the Kalman gain, which reflects the relative trust in the prediction versus the sensor data. In particular, a higher Kalman gain indicates greater confidence in the sensor data, which will then have more influence on the updated state estimate. The filter combines the prediction with the new sensor data, weighted by the Kalman gain, to produce a refined state estimate and also updates the error covariance to represent the uncertainty of the new estimate. This process allows the Kalman filter to effectively fuse data from multiple sensors, each with its own noise characteristics, to provide a consistent and accurate estimate of the state of the railway vehicle in real-time.

In some embodiments, the method may further include causing the railway vehicle to move along the track according to a predefined trajectory, which enables sensor data to be gathered while the railway vehicle moves according to the known trajectory. For instance, the predefined trajectory can specify for the railway vehicle to travel in a first direction along the track for a first distance and then to move in a second direction (opposite direction) along the track for a second distance. The sensor data may be received as the railway vehicle moves in the first direction and the second direction along the track. With knowledge of the predefined trajectory, the computing system may use the sensor data gathered during the predefined trajectory to generate the profile for the railway vehicle. For instance, the computing system may use a model in addition to the sensor data gathered during the predefined trajectory to help with the mass estimation for the railway vehicle.

In some cases, the method may also include comparing the estimated mass of the railway vehicle with a predefined mass of the railway vehicle, where the predefined mass of the railway vehicle indicates a measured mass of the railway vehicle in an empty state. Based on the comparison, the weight of materials or other types of cargo carried by the railway vehicle may be determined. For example, a computing system may remove the predefined mass of the railway vehicle from the estimated total mass of the railway vehicle to determine the weight of goods, materials, or another type of cargo carried by the railway vehicle. In some examples, the method can be used to estimate the weight of passengers and their cargo traveling upon a passenger railway vehicle.

In some embodiments, the method may further include detecting a position of the railway vehicle's proximity relative to a drop zone based on additional sensor data received from the sensors, and triggering an automatic release of the cargo by the railway vehicle at the drop zone. The automatic release of the cargo may be triggered by modifying a state of an electric solenoid coupled to the railway vehicle, such that the railway vehicle drops the cargo at the drop zone.

In some aspects, the computing system may determine the position of the railway vehicle relative to a drop zone by employing a suite of onboard sensors and external references. For instance, the computing system may use a Global Positioning System (GPS) receiver to determine the railway vehicle's geographical coordinates for a broad location fix and acceleration and angular velocity data from an IMU to track its movements incrementally-a technique known as dead reckoning. In some instances, wheel encoders may be used for another layer of precision by measuring the distance traveled based on wheel rotations. Together, the sensors may offer a dynamic and continuous estimate of the railway vehicle's position. For more granular localization, the computing system monitoring the railway vehicle can utilize Radio Frequency Identification (RFID) technology. RFID tags placed along the track at known intervals can be detected by an onboard RFID reader, offering exact location markers that help calibrate the position of the railway vehicle. This can be particularly useful for confirming the location of the railway vehicle as it approaches the drop zone.

In some examples, an onboard computing system uses data fusion algorithms, such as the Kalman filter, to integrate the data from GPS, IMU, wheel encoders, and RFID systems as well as other potential sensors. The multi-sensor approach can mitigate individual sensor inaccuracies, provide redundancy in case a sensor fails, and provide a robust estimate of the location of the railway vehicle. As the railway vehicle nears the drop zone, the computing system can compare the real-time position of the railway vehicle with the pre-programmed coordinates of the drop zone. Upon confirming the position of the railway vehicle within the drop zone, the computing system can automatically trigger the dump mechanism of the railway vehicle, precisely unloading the cargo at the intended location through a control system that activates the appropriate actuators. In some cases, the computing system may communicate with a remote computing system to coordinate the release of the cargo at the drop zone.

In some examples, a railway vehicle can utilize a combination of advanced sensing technologies to accurately localize its position relative to a drop zone. For instance, one or more cameras can be mounted on the railway vehicle to capture real-time visual data, which, when processed using computer vision algorithms, can identify trackside landmarks and signs indicative of the railway vehicle's location. One or more LiDAR sensors positioned on the railway vehicle can be also used. A LiDAR sensor may emit laser pulses to create a detailed 3D map of the surroundings, pinpointing the position of the railway vehicle by measuring distances to known features positioned along the track. In some cases, radar can further enhance localization determination by using radio waves to detect and measure the range, velocity, and angle of surrounding objects, providing reliable data even in adverse weather conditions.

In some cases, a computing system may integrate the diverse data streams from cameras, LiDAR, radar, and traditional navigation sensors like GPS and IMUs through sensor fusion algorithms. The algorithms, such as Kalman filters, are used to synthesize the information to produce a unified and precise location estimate. Additionally, the computing system on the railway vehicle can communicate with external systems, including trackside sensors and central traffic management systems, to validate the position of the railway vehicle and receive updates on the drop zone's status. The multi-layered approach to localization can ensure that the railway vehicle is able to accurately determine when it has reached the drop zone, facilitating the timely and precise release of materials or other types of cargo.

In some examples, the method may further include providing a signal to a remote computing device, where the signal indicates information about the railway vehicle. For instance, the signal may indicate that the railway vehicle is positioned within the drop zone and ready to deploy its materials or other types of cargo at the drop zone. As such, the automatic release of the cargo by the railway vehicle at the drop zone may be triggered in response to receiving a response from the remote computing device. For example, a remote operator or the remote computing device may analyze the information within the signal and trigger the release of the cargo being carried by the railway vehicle.

In some examples, the method may further include receiving a signal that indicates a change in state of a pneumatic switch, which can be coupled on a railway vehicle to determine when the railway vehicle has been loaded. The profile for the railway vehicle that represents the acceleration and force upon the railway vehicle during movement along the track may be generated in response to receiving the signal. For instance, the change in state of the pneumatic switch may signal that the weight of the railway vehicle has changed, which can prompt one or more onboard computing systems to perform disclosed operations to estimate the mass of the railway vehicle.

In some cases, the method may further include performing a calibration run with the railway vehicle in an empty state to determine the predefined mass of the railway vehicle. The calibration run may involve moving the railway vehicle along the track according to a predefined trajectory, receiving sensor data from sensors as the railway vehicle moves along the track, and estimating the mass of the railway vehicle in the empty state based on the sensor data. In some instances, the method may further include adjusting the predefined trajectory based on the estimated mass of the railway vehicle. The adjusted trajectory may be used to optimize the performance of the railway vehicle, reduce energy consumption, or improve the accuracy of the mass estimation.

In some cases, the method may further include adjusting the operation of the motor or motors used to propel the railway vehicle based on the estimated mass of the railway vehicle. The adjustment may involve changing the torque output by the motor or motors, adjusting the speed of the motor or motors, or modifying other operating parameters of the motor or motors.

In some examples, the method may further include adjusting the operation of the dump subsystem based on the estimated mass of the railway vehicle. The adjustment may involve changing the timing or sequence of the dumping process, modifying the actuation mechanism of the dump subsystem, or adjusting other operating parameters of the dump subsystem. In addition, the method may also include adjusting the operation of the brake system used by the railway vehicle based on the estimated mass of the railway vehicle. The adjustment may involve changing the braking force, adjusting the braking distance, or modifying other operating parameters of the brake system.

Different types of vehicles can be used for disclosed techniques and are not limited to railway vehicles. For instance, trucks, cars, robotic devices, aircraft, drones, construction equipment, farm equipment, trolleys, and other types of vehicles can perform disclosed techniques. The following description and accompanying drawings will elucidate features of various example embodiments. The embodiments provided are by way of example, and are not intended to be limiting. As such, the dimensions of the drawings are not necessarily to scale. Example systems and methods within the scope of the present disclosure will now be described in greater detail.

### I. Example Systems

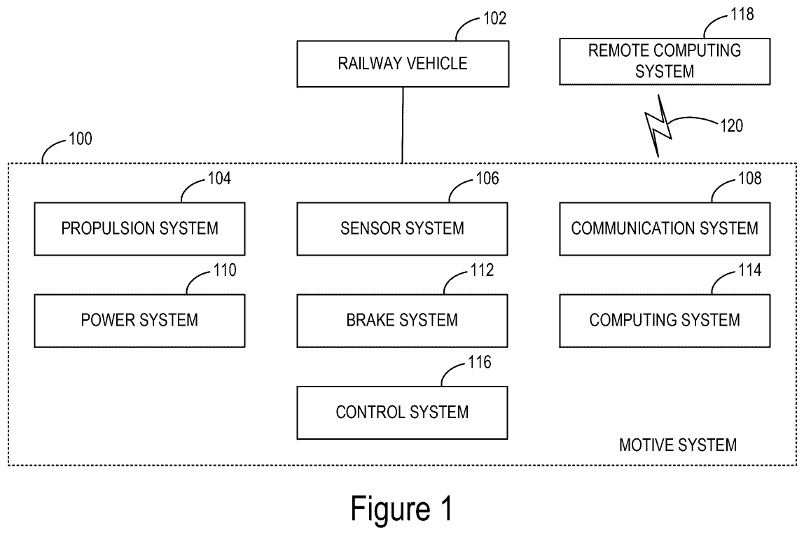

Referring now to the figures, FIG. 1 is a functional block diagram showing motive system 100, which can be implemented on railway vehicle 102 and configured to perform disclosed operations. In the example embodiment, motive system 100 may include various subsystems, such as propulsion system 104, sensor system 106, communication system 108, power system 110, brake system 112, computing system 114, and control system 116. In other examples, motive system 100 may include more or fewer subsystems. In addition, the subsystems and other components of motive system 100 can be interconnected via wired or wireless connections and operations performed by motive system 100 can be divided into additional functional or physical components and/or combined into fewer functional or physical components within examples.

Railway vehicle 102 represents any type of vehicle that can transport people and/or cargo on a railway. In some examples, railway vehicle 102 may be a freight car or a flatcar configured to move materials or other types of materials. In particular, railway vehicle 102 is a burdened rail vehicle in some embodiments. Traditional locomotives are unburdened (i.e., not carrying payload) whereas traditional freight railcars are unpowered and serve to carry payloads similar to trailers as burdened vehicles. As such, the size, shape, and configuration of railway vehicle 102 can differ within examples. In addition, the number and types of axles and wheels on railway vehicle 102 can vary. Generally, railway vehicle 102 may include two axles per truck with two trucks per railcar. Railway vehicle 102 may include one or multiple types of couplers that enable railway vehicle 102 to be coupled to other railway vehicles.

Motive system 100 may include propulsion system 104 in some examples. As such, propulsion system 104 may include one or multiple components configured to supply powered motion for railway vehicle 102. For instance, propulsion system 104 may include one or multiple motors that can use power from power system 110 to generate torque to rotate wheels of railway vehicle 102. In some embodiments, propulsion system 104 may include multiple types of engines and/or motors.

Sensor system 106 may include one or multiple types of sensors that can be used to enhance the performance of railway vehicle 102. Generally, sensor system 106 can be utilized to understand the environment of railway vehicle 102, the performance of components of railway vehicle 102, and enable tailoring performance of railway vehicle 102 towards the environment. For instance, sensor system 106 may include one or more radars, LiDARss, cameras, wind sensors, force sensors, contact sensors, precipitation sensors, light sensors, humidity sensors, strain gauges, thermal imaging, radio navigation units, encoders, resolvers, laser range finding sensors, Radio-Frequency Identification (RFID) sensors, gyroscopes and/or magnetometers, accelerometers, magnetic sensors, microphones, strain and weight sensors, Global Positioning Systems (GPS), inertial measurement units (IMUs), passive infrared sensors, ultrasonic sensors, wheel speed sensors, and/or throttle/brake sensors, among other possibilities. Sensor system 106 may also include one or multiple sensors configured to monitor existing components of railway vehicle 102. In addition, sensor system 106 can use multiple sensors to provide for safety redundancy.

Various sensors from sensor system 106 can be placed on different components of railway vehicle 102. For instance, some sensors can be positioned on couplers while others are housed in a particular container positioned near a front or a rear end of railway vehicle 102. Some sensors can measure aspects of couplers positioned on railway vehicle 102. For instance, these sensors can indicate the stress level on couplers, among other information.

In some examples, sensor system 106 may include one or multiple sensors that can detect waypoints positioned along a railway track. Sensor system 106 may also enable railway vehicle 102 to triangulate its position relative to off board radio stations and/or other sources of communication signals, such as 4G or 5G cellular towers. Sensor system 106 can also be used to weigh railway vehicle 102 and adjust performance of electric motors and/or other components located on railway vehicle 102. In some examples, sensor system 106 can be supplemented by one or multiple devices disclosed herein.

In some examples, a motor encoder and/or resolver data can be used to detect wheel slipping on railway vehicle 102 due to wet, icy, or debris laden tracks. In response, computing system 114 may then implement effective control strategies such as dispensing sand in front of the wheels to prevent slippage. Onboard sensors can be used to detect vandals in some embodiments. Computing system 114 may use cameras and radar to detect potential vandalism and responsively transmit signals to a user and/or authorities to protect cargo and payloads via communication system 108. In addition, sensor system 106 can be used for automated track inspections and to determine rail condition. In some cases, computing system 114 may determine deviation from normal rail characteristics based on sensor data from sensor system 106. For instance, computing system 114 may detect railcar hunting, vibration, and/or other dynamics based on sensor data.

As further shown in FIG. 1, motive system 100 may include communication system 108, which may be used to communicate with one or more devices (e.g., remote computing system 118) directly or via a communication network (e.g., wireless connection 120). In some examples, communication system 108 may include one or multiple dedicated short-range communications (DSRC) devices that could include public and/or private data communications with stations positioned near tracks.

Power system 110 may include one or multiple power sources that can supply power to different components of motive system 100 and/or railway vehicle 102. For instance, power system 110 may include batteries, petroleum-based fuels, gas-based fuels, solar panels, among other types of power generation sources. In some example embodiments, power system 110 may include a combination of batteries, capacitors, and/or flywheels. In some cases, power system 110 may be shared across multiple railway vehicles within a train set. For instance, direct electrical connections can exist between power systems on different railway vehicles. In addition, multiple power systems can be used to share energy in optimal ways, such as using an overcharged battery pack to kinetically recharge a depleted or lower state of charge battery pack. In some examples, power system 110 can supply power to one or multiple train recording devices described herein.

Brake system 112 may represent one or multiple supplementary brake systems that motive system 100 may include to further enhance performance of railway vehicle 102. The primary braking system can be pneumatic, with brake airlines pressurized from compressors on board the railway vehicle, and used in conjunction with brake system 112. For instance, brake system 112 is a regenerative brake system in some embodiments. As a regenerative system, brake system 112 can serve as an energy recovery mechanism that also slows down the railway vehicle by converting its kinetic energy into a form that can be used immediately or stored until needed. For instance, brake system 112 can convert kinetic energy into energy stored by one or more batteries of power system 110. In some instances, brake system 112 can dissipate the energy as heat, such as when the battery storage on railway vehicle 102 is full.

In some embodiments, brake system 112 can be a regenerative braking system that can be used to feed electricity directly into the electrical grid through overhead catenary lines or other technologies (e.g., third rails used for power). Brake system 112 can also be used during short sections of track without requiring full electrification of the track lines to take advantage of traditional un-electrified rail as well as short electrified sections for recharging and returning power to the grid.

Computing system 114 represents one or multiple computing devices that can perform operations, such as the various operations described herein. Computing system 114 may include one or multiple processors that can execute instructions stored in a non-transitory computer readable medium (e.g., data storage). The instructions can enable computing system 114 to operate with the various subsystems of motive system 100 and other computing devices (e.g., remote computing system 118). In some examples, motive system 100 may use communication system 108 to communicate with remote computing system 118 over wireless connection 120. In addition, computing system 114 may include one or multiple user interface elements to enable users to provide instructions and/or receive information from motive system 100. For instance, computing system 114 may include one or more input/output devices, such as a touchscreen, tablet, keyboard, speaker, and microphone, etc.

In some embodiments, computing system 114 is designed to be self-redundant in order to offer duplex or triplex redundancy in case of a partial system failure. This allows for computing system 114 to continue operations safely in case of a failure as well as to have a redundant system verifying and validating sensor inputs received from sensor system 106.

Control system 116 can include one or multiple components designed to assist in the operations of railway vehicle 102. For instance, control system 116 can include components that enable control of other components of motive system 100 and/or a proportional-integral-derivative controller (PID controller or three-term controller) that is a control loop mechanism employing feedback that is widely used in industrial control systems and a variety of other applications requiring continuously modulated and adaptive control.

Remote computing system 118 represents a computing system that may provide information and/or control instructions to motive system 100 and/or railway vehicle 102. For instance, remote computing system 118 may be a smartphone, server, laptop, and/or another type of device that enables inputs to different components within motive system 100.

Motive system 100 can include other pneumatic elements for auxiliary services, such as dump, gate, or door actuation. These systems can be actuated via solenoids remotely or manually. Gate or door actuation can be supplied from the same compressors or completely separate air systems from the brake air infrastructure. In addition, motive system 100 can also include additional systems, such as a cooling system that can service the needs of other systems. For instance, the cooling system can cool onboard battery storage, electric motors, inverters using liquid or air cooled subsystems in order to keep the components in satisfactory operating temperatures. In some implementations, compressors and air drying/treating equipment for pneumatic systems can use a cooling system. As such, cooling systems could link between other systems on a single loop, in series or parallel. In other cases, each system may have its own subsystem for cooling. A combination of a master cooling system and additional cooling subsystems can be used in other examples.

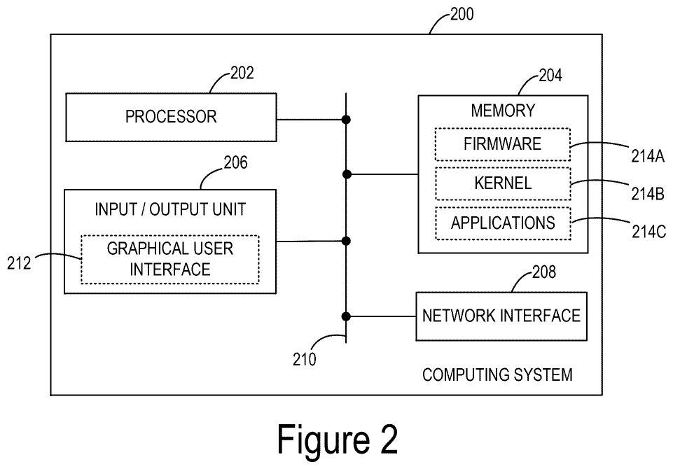

FIG. 2 is a block diagram of computing system 200, illustrating some of the components that could be included in a computing device arranged to operate in accordance with the embodiments herein. As such, computing system 200 may be implemented as computing system 114 of motive system 100 and/or remote computing system 118 shown in FIG. 1. In some examples, computing system 200 may communicate with one or more accessories attached to a railway vehicle via one or more bearing adapters.

In the example embodiment shown in FIG. 2, computing system 200 includes processor 202, memory 204, input/output unit 206, and network interface 208, all of which may be connected by a system bus 210 or a similar mechanism. In some example embodiments, computing system 200 may include other components and/or peripheral devices (e.g., detachable storage and/or sensors).

Processor 202 may be one or more of any type of computer processing element, such as a central processing unit (CPU), a co-processor (e.g., a graphics processor), a digital signal processor (DSP), a network processor, and/or a form of integrated circuit such as a Field Programmable Gate Array (FPGA), or controller that performs processor operations. As such, processor 202 may be one or more single-core processors and/or one or more multi-core processors with multiple independent processing units. In addition, processor 202 may also include register memory for temporarily storing instructions being executed and related data, as well as cache memory for temporarily storing recently-used instructions and data.

Memory 204 may be any form of computer-usable memory, including but not limited to random access memory (RAM), read-only memory (ROM), and non-volatile memory. This may include flash memory, hard disk drives, solid state drives, rewritable compact discs (CDs), rewritable digital video discs (DVDs), and/or tape storage, as just a few examples. Computing system 200 may include fixed memory as well as one or more removable memory units, the latter including but not limited to various types of secure digital (SD) cards. As an example result, memory 204 can represent both main memory units as well as long-term storage. Memory 204 may store program instructions and/or data on which program instructions may operate. By way of example, memory 204 may store these program instructions on a non-transitory, computer-readable medium, such that the instructions are executable by processor 202 to perform any of the methods, processes, or operations disclosed in this specification or the accompanying drawings.

As shown in FIG. 2, memory 204 may include firmware 214A, kernel 214B, and/or applications 214C. Firmware 214A may be program code used to boot or otherwise initiate some or all of computing system 200. Kernel 214B may be an operating system, including modules for memory management, scheduling and management of processes, input/output, and communication. In addition, kernel 214B may also include device drivers that allow the operating system to communicate with the hardware modules (e.g., memory units, networking interfaces, ports, and busses) of computing system 200. Applications 214C may be one or more user-space software programs, such as web browsers or email clients, as well as any software libraries used by these programs. In some examples, applications 214C may include one or more embedded systems, control systems 116, neural network applications and other deep learning-based applications. Memory 204 may also store data used by these and other programs and applications.

Input/output unit 206 may facilitate user and peripheral device interaction with computing system 200, sensors, and/or other computing systems, such as computing systems on other railway vehicles and/or positioned remote from a train. Input/output unit 206 may include one or more types of input devices, such as a keyboard, a mouse, one or more touch screens, sensors, biometric sensors, and so on. Similarly, input/output unit 206 may include one or more types of output devices, such as a screen, monitor, printer, speakers, and/or one or more light emitting diodes (LEDs). Additionally or alternatively, computing system 200 may communicate with other devices using a universal serial bus (USB) or high-definition multimedia interface (HDMI) port interface, for example. In some examples, input/output unit 206 can be configured to receive data from other devices. For instance, input/output unit 206 may receive sensor data from sensors, such as sensors positioned on a railway vehicle. As shown in FIG. 2, input/output unit 206 includes Graphical User Interface (GUI) 212, which can be configured to provide information to a user. GUI 212 may involve one or more display interfaces, or another type of mechanism for conveying information and receiving inputs. Some common rail techniques can involve signal lighting, horns, and bells, which can be implemented via input/output unit 206. With many techniques in traditional rail being visual and auditory in nature, these techniques in addition to more advanced signaling and human machine interfaces can be implemented.

Network interface 208 may take the form of one or more wireline interfaces (e.g., Ethernet, Controller Area Network (CAN)) and/or enable communication over one or more wireless interfaces, such as IEEE 802.11 (Wi-Fi), BLUETOOTH®, global positioning system (GPS), 3G, 4G, 5G, or a wide-area wireless interface. In addition, other forms of physical layer interfaces and other types of standard or proprietary communication protocols may be used over network interface 208.

### II. Example Railway Vehicle Configurations

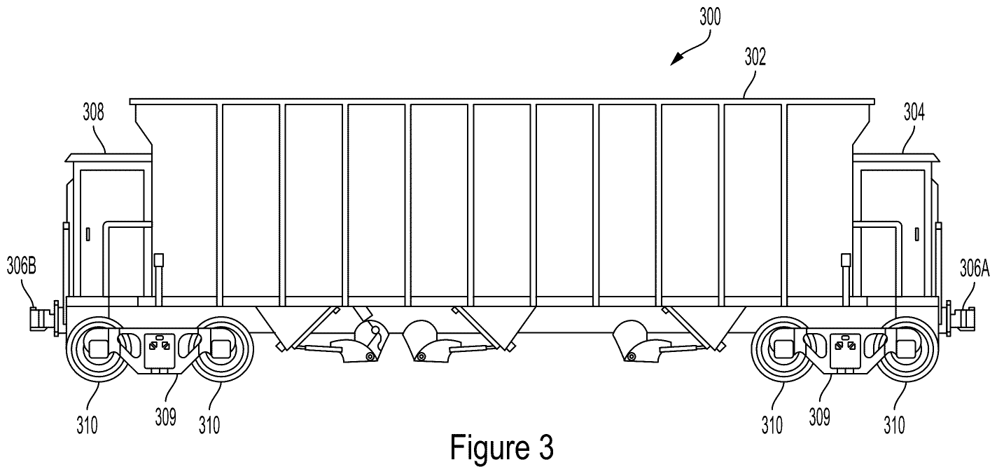

FIG. 3 illustrates a configuration of railway vehicle 302 equipped with motive system 300. In the example embodiment, motive system 300 is implemented on railway vehicle 302 and includes sensor system 304 positioned near front coupler 306A and battery storage 308 located near rear coupler 306B. Railway vehicle 302 may include one or more train recording and event notification devices described herein.

In the example embodiment, railway vehicle 302 is shown as a freight vehicle designed to carry materials and other cargo between locations. Railway vehicle 302 has front side 312 and rear side 314 in the example embodiment, which can each be attached to different railway vehicles within a trainset via front coupler 306A and rear coupler 306, respectively. As shown, railway vehicle 302 includes bogies 309 (or trucks) that enable movement on wheels 310. As such, motive system 300 can involve installation of one or multiple components (e.g., electric motors, braking systems) on bogies 309 via one or more bearing adapters and other components of railway vehicle 302. Railway vehicle 302 can have alternative configurations within other embodiments. In addition, railway vehicle 302 can be part of a train that includes one or multiple railway vehicles equipped with motive systems 300.

Motive system 300 can be implemented as motive system 100 shown in FIG. 1 and can include one or more electric drive systems and an auxiliary braking system that can enable motive system 300 to perform operations disclosed herein that can enhance overall performance of railway vehicle 302. For instance, motive system 300 may include one or multiple electric drivetrains that can be used to turn axles connected to wheels 310. In addition, motive system 300 may also include a regenerative braking system that can be used to convert energy from one or more axles and/or wheels 310 and deliver energy to battery storage 308 during braking applications.

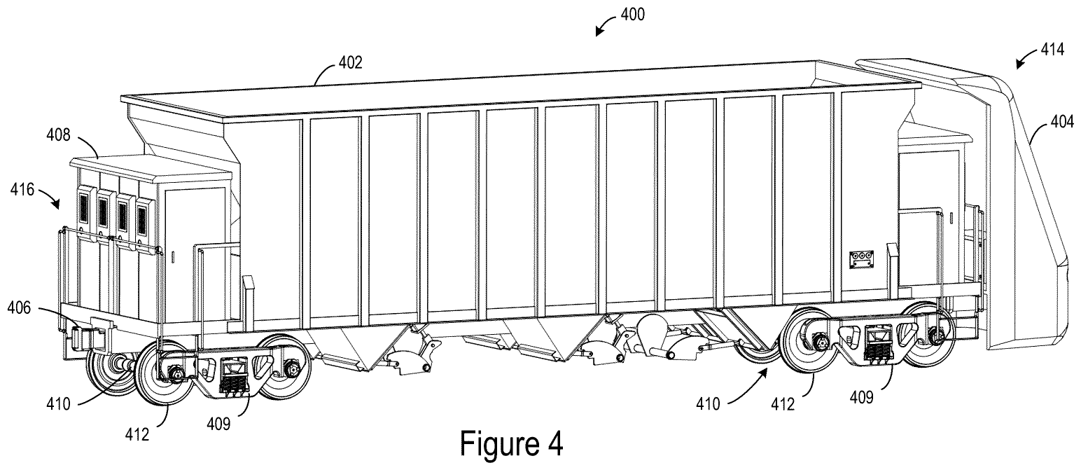

FIG. 4 illustrates another configuration of railway vehicle 402 configured with motive system 400, which can similarly include components of motive system 100 shown in FIG. 1 and may enable railway vehicle 402 to operate autonomously and without locomotives.

Railway vehicle 402 is similar to railway vehicle 302 shown in FIG. 3, but differs at the front end of railway vehicle 402. In particular, motive system 400 implemented on railway vehicle 402 includes sensor component 404 that may include additional sensors (e.g., cameras, radar, LiDAR) to enable railway vehicle 402 to perform operations typically completed by a locomotive. Railway vehicle 402 includes coupler 406 and bogies 409 configured with axles 410 and wheels 412 as shown in FIG. 4. As such, bogies 409 and disclosed bearing adapters can be used to position motors and/or other components that enable railway vehicle 402 to be self-propelled. In some examples, regenerative braking components can be attached to axles 410, bogies 409, and/or wheels 412. In addition, housing 408 may include batteries and/or other components for motive system 400. Railway vehicle 402 has front side 414 and rear side 416 as shown in FIG. 4. Rear side 416 can be coupled to another railway vehicle within a train set via coupler 406.

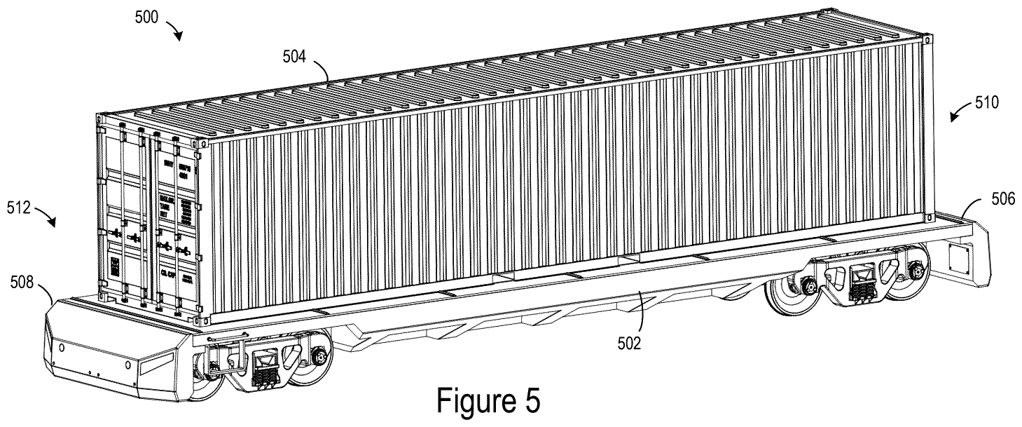

FIG. 5 illustrates an additional configuration of railway vehicle 502 configured with motive system 500, which can similarly include components of motive system 100 shown in FIG. 1 and may enable railway vehicle 502 to operate autonomously and without locomotives. Similar to the examples shown in FIG. 3 and FIG. 4, motive system 500 can include components that can enhance performance of railway vehicle 502.

In the example embodiment, railway vehicle 502 has a flat design to enable one or multiple containers (e.g., shipping container 504) to be positioned on top. Motive system 500 implemented on railway vehicle 502 includes front component 506 positioned at front side 510 and rear component 508 positioned at rear side 512. One or both of front component 506 and rear component 508 can include various components of motive system 500, such as sensors, energy storage (e.g., batteries), etc. In addition, the bogies of railway vehicle 502 can similarly include components of motive system 500, such as regenerative brakes, motors, etc. Motive system 500 can also be designed for standard coupling interfaces and may use one or multiple bearing adapters disclosed herein.

In addition, each railway vehicle 302, 402, 502 can further include additional components, such as emergency brakes, lights, and horns.

### III. Example Systems

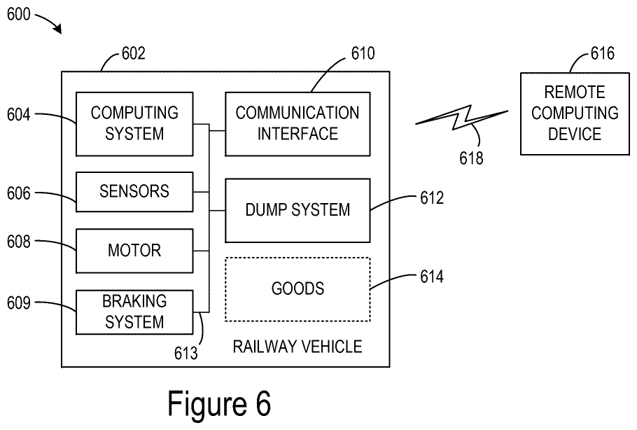

FIG. 6 illustrates a functional block diagram of system 600, engineered for precise measurement of the weight of goods transported by a railway vehicle and for enabling their automated deployment at a predetermined location. As shown in FIG. 6, system 600 integrates various components within railway vehicle 602, including computing system 604, an array of sensors 606, motor 608, braking system 609, communication interface 610, dump subsystem 612, and goods 614. Components within system 600 may be connected via connection mechanism 613, which may represent various types of wired and/or wireless connections. Additionally, computing system 604 is capable of wireless communication 618 with external devices, such as remote computing device 616.

System 600 embodies a synergy of hardware and software designed to execute the operations disclosed herein. As such, system 600 can serve dual purposes: estimating the mass of railway vehicle 602, inclusive of the weight of goods 614 it carries, and facilitating the automated release of goods 614 at a desired drop location. Specifically, dump subsystem 612 is configured to manage the dumping process, which can be initiated locally or remotely, to ensure the precise delivery of goods 614 at a designated location. The configuration of system 600 and its components may vary, with the potential for division or amalgamation in alternative embodiments.

Railway vehicle 602 is adaptable to various vehicle types that traverse rail tracks. Examples include railway vehicles depicted in FIGS. 3, 4, and 5, with railway vehicle 602 potentially being a specialized freight car tailored for specific cargo requirements. For instance, railway vehicle 602 could be a boxcar with protective walls and roofing or a flatcar designed for heavy or oversized loads. Other variations may include gondolas, hopper cars, tank cars, refrigerated cars, intermodal containers, autoracks, and more, each specialized for distinct functions. In some examples, railway vehicle 602 is replaced by another type of vehicle that may travel without reliance upon tracks. For instance, buses, trucks, cars, farm equipment, robots, aircraft, drones, and/or other types of vehicles may be used.

In some embodiments, railway vehicle 602 may incorporate or be retrofitted with components that enhance its operational capabilities. These components can be integrated into existing railway vehicles using various coupling mechanisms. Computing system 604, for example, may consist of a singular device or a network of devices, either onboard or external to railway vehicle 602. Equipped with processors and memory, computing system 604 may process sensor data, manage vehicle operations, and interface with other systems or devices, including motor 608 and onboard power sources like batteries.

The placement of computing system 604 may be determined by the functional requirements and the layout of railway vehicle 602. For instance, computing system 604 may be situated in proximity to motor 608 and power sources to facilitate control over the propulsion and/or braking of railway vehicle 602. Computing devices may be installed directly on railway vehicle 602, housed in protective compartments, and/or located in centralized control centers for remote management of multiple vehicles.

In addition, as further shown in FIG. 6, railway vehicle 602 is outfitted with a suite of sensors 606. Example sensors 606 may include, but are not limited to, IMUs, torque sensors, accelerometers, cameras, LiDAR, radar, torque sensors, gyroscopes, strain sensors, and GNSS receivers. These sensors can be strategically positioned to capture pertinent data, such as acceleration via IMUs and accelerometers, and motor force via torque sensors. GNSS receivers can be used to track the position and velocity of railway vehicle 602, with sensor data being provided to computing system 604 for processing.

Sensors 606, which may include accelerometers, gyroscopes, IMUs, wheel slip sensors, GNSS sensors, and strain gauges, are adept at capturing various aspects of the dynamics and motions of railway vehicle 602. For instance, accelerometers, attached to the chassis or wheelsets, measure velocity changes, while gyroscopes, measuring rotational rates, complement accelerometers to provide comprehensive acceleration data. In some cases, IMUs are used to combine these measurements, offering detailed motion profiles across multiple axes. GNSS sensors, though not direct acceleration measurers, can be used to track positional and velocity changes over time, enabling acceleration computation. Strain gauges, affixed to structural elements, can be used to quantify the deformation due to applied forces, and wheel slip sensors, located near the wheel-rail interface, can be used to detect traction losses indicative of acceleration or deceleration.

In some cases, sensors 606 may also encompass devices like load cells, torque sensors, and strain gauges, which measure the forces exerted on railway vehicle 602 and the torque produced by motor 608. Load cells, placed under wheels or between the chassis and bogie, can be used to directly gauge forces, while strain gauges can be attached to the frame, axles, or suspension to measure deformation-related forces. Torque sensors can be integrated into the shaft of motor 608 or drivetrain components and used to measure and quantify the twisting force output. In some instances, pressure sensors may monitor the hydraulic or pneumatic pressures within braking or suspension systems, with changes reflecting applied forces. Current sensors estimate the torque and force generated by motor 608 by measuring the electrical current supplied to it. Strain gauge transducers may be used to convert force into electrical signals, useful for direct force measurement or monitoring motor exertion. Accelerometers can indirectly estimate dynamic forces on railway vehicle 602, and encoders may be used to provide feedback on motor shaft rotation, aiding in torque and force determination.

Sensors 606 may interface with computing system 604 via wired or wireless connections, such as Ethernet, CAN, Wi-Fi, or Bluetooth, enabling real-time monitoring and control of the dynamics or railway vehicle 602. Computing system 604, leveraging sensor data, may calculate the force and acceleration applied to railway vehicle 602 to determine its mass using Newton's second law. The weight of goods 614 is ascertained by subtracting the known empty mass of railway vehicle 602 from the total mass estimated for railway vehicle 602. Kalman filters may refine these measurements, accounting for external forces like friction, air resistance, and track gradients, with models factoring in environmental conditions to enhance mass calculation accuracy.

In some examples, various filters can be adeptly applied by computing system 604 to process sensor data for accurate state estimation, including the mass of railway vehicle 602 and its precise location relative to a drop zone for goods deployment. For instance, the Extended Kalman Filter (EKF) and the Unscented Kalman Filter (UKF) are particularly useful for handling the non-linear dynamics of movement by railway vehicle 602. The EKF can approximate the railway vehicle's behavior around a current estimate, which is beneficial for moderate non-linearities encountered during rail travel. The UKF, with its unscented transform, may provide a more accurate state estimation when the motion of railway vehicle 602 exhibits stronger non-linear characteristics, such as when navigating curves or slopes.

In some scenarios where the sensor data obtained by sensors 606 is heavily influenced by non-Gaussian noise or the dynamics of railway vehicle 602 are deeply non-linear, a Particle Filter may be used, which represents the possible states of railway vehicle 602 with a set of particles. Each particle's evolution may capture a potential trajectory of railway vehicle 602, allowing for a comprehensive estimation of the mass and location of railway vehicle 602. In some cases, computing system 604 may use an Ensemble Kalman Filter (EnKF) for processing the vast amount of data produced by sensors 606. The EnKF uses multiple forecasts to estimate the current state of railway vehicle 602, which can be instrumental in determining the mass of railway vehicle 602 and ensuring precise deployment of goods 614 at the designated drop zone.

Computing system 604 may use one or multiple advanced filtering techniques to process the sensor data obtained from sensors 606, such as from accelerometers, strain gauges, and GPS. In particular, the techniques may be used by computing system 604 to estimate the mass of railway vehicle 602 by analyzing the forces and accelerations acting on it and also to pinpoint the location of railway vehicle 602 with respect to a drop zone. By integrating these filters with onboard computing system 604, the processed data can trigger automated mechanisms (e.g., dump subsystem 612) for the timely and accurate unloading of goods, enhancing the efficiency and reliability of railway logistics operations.

In some examples, computing system 604 may use a model to accurately measure the acceleration of a railway vehicle while factoring in external friction and environmental conditions such as wind, temperature, and weather. The model may integrate various physical forces into the equations of motion governing the dynamics of railway vehicle 602. For instance, rolling resistance, which represents the frictional force between the train wheels and the rails, may be factored. The rolling resistance can depend on the weight of railway vehicle 602, the condition of the wheels and rails, and the presence of environmental contaminants. The model may use a coefficient of rolling resistance that can be empirically determined or sourced from industry standards to quantify this frictional force.

In addition, in some examples, aerodynamic factors may also be considered, with wind resistance being a function of the shape and surface area of railway vehicle 602 and the relative wind speed and direction. For instance, the model may apply the drag equation, incorporating the drag coefficient, air density (which changes with altitude and temperature), and the velocity of the wind relative to railway vehicle 602. Temperature impacts may also be accounted for as well, as temperature can influence the performance of motor 608, air density for drag calculations, and the physical properties of the materials of railway vehicle 602, such as thermal expansion or contraction.

In some cases, the model may include weather conditions that introduce additional forces, like side winds causing lateral forces or precipitation affecting traction and braking. Real-time data from onboard sensors and weather stations can be used to adjust the force calculations dynamically. The accuracy of the model can be improved and ensured through calibration with controlled test runs, aligning the coefficients and variables with a railway vehicle's actual response to various conditions. Validation can then be achieved by comparing the model's output with real-world performance data across diverse operational scenarios. The integration of real-time environmental data and precise modeling may allow for enhanced control over the performance of railway vehicle 602, leading to gains in efficiency, safety, and adherence to schedules.

Motor 608, which may be an electric or alternative type motor, propels railway vehicle 602 and interfaces with computing system 604 for force output measurement. The parameters of motor 608 can impact the performance, efficiency, and operational capabilities of railway vehicle 602. In some aspects, motor 608 may include one or more DC motors, which can adjust speed and torque for use across a range of applications. For instance, railway vehicle 602 may be retrofitted with series-wound, shunt-wound, or compound-wound DC motors, each offering different characteristics in terms of speed regulation and torque generation. I

Motor 608 can include other types of motors, such as AC induction motors that are robust and typically require low maintenance, making them a reliable option for railway operations. AC induction motors typically operate in conjunction with variable frequency drives (VFDs), which allow for precise control of motor speed, an advantage when adapting to varying load conditions and track profiles. In some cases, AC induction motors may provide good high-speed performance, which can be used for modernizing older railway vehicles.

In addition to DC and AC induction motors, there are other motor technologies that can be used to enhance performance of railway vehicle 602. For instance, permanent magnet motors may provide high efficiency and superior power-to-weight ratio for use by railway vehicles. Permanent magnet motors utilize permanent magnets to create a magnetic field, which can result in reduced energy losses and improved overall performance. Brushless DC motors are also an option for propelling railway vehicle 602. A brushless DC motor can offer the benefits of high efficiency and a maintenance-free design due to the absence of brushes, which are prone to wear and tear. In some examples, railway vehicle 602 may lack any motors and depend on a locomotive or another railway vehicle to supply force for movement. For instance, railway vehicle 602 may carry materials or other types of goods 614 as part of a larger train.

When railway vehicle 602 is an older railcar that is retrofitted with motor 608, motor 608 may be connected to other systems on railway vehicle 602, such as computing system 604. In particular, computing system 604 may supply controls that adjust the torque generated by motor 608. In addition, motor 608 may be integrated with power electronics, one or more power sources, cooling systems, and the mechanical structure of railway vehicle 602. Retrofitting railway vehicle 602 with such equipment can increase energy efficiency, enhance performance, reduce emissions, and/or comply with updated regulations, while also maintaining the reliability and safety standards of railway vehicle 602.

Braking system 609 may represent one or more types of braking subsystems that can be used by railway vehicle 602. For instance, braking system 609 may include a regenerative braking system that is designed to recover kinetic energy that would otherwise be lost as heat during the braking process. When railway vehicle 602 decelerates, the regenerative braking system converts the kinetic energy into electrical energy, which can then be used to recharge the onboard batteries. This process not just slows down railway vehicle 602 but also contributes to the energy efficiency of railway vehicle 602 by capturing energy that would typically be dissipated.

In some aspects, the regenerative braking system may be integrated with the power system of the railway vehicle, which includes the batteries that store electrical energy. When the regenerative brakes are engaged, the electrical energy generated is directed to the batteries, where it is stored for future use. This energy can then be used to power various components within the system, such as the propulsion system (e.g., motor 608), lighting, climate control, onboard electronics, sensors 606, communication system 610, and dump system 612. By recharging the batteries during braking, braking system 609 can extend the operational range of railway vehicle 602 and reduce the frequency of charging from external sources.

In some examples, the regenerative braking system may be designed to work in conjunction with traditional friction brakes to ensure the safety and reliability of the braking process. While the regenerative brakes are effective in slowing down the train and recovering energy, the friction brakes can be used as a backup or when additional braking force is required, such as in emergency situations or when the batteries are fully charged and cannot accept additional energy. In some cases, the regenerative braking system may also be capable of feeding the recovered electrical energy back into the electrical grid, especially if railway vehicle 602 is equipped with a connection to an overhead catenary system or a third rail. This feature allows railway vehicle 602 to contribute to the energy supply of the grid, further enhancing the sustainability of the railway transportation system. In addition, the control system of railway vehicle 602 may include algorithms that optimize the use of regenerative braking based on various factors, such as the state of charge of the batteries, the speed of the train, and the topography of the route. By intelligently managing the regenerative braking process, the system can maximize energy recovery and ensure that the batteries are maintained at an optimum level of charge, ready to power the train's components as and when they are needed.

Communication interface 610 facilitates data exchange between computing system 604 and external devices or systems, supporting protocols like Wi-Fi, Bluetooth, LoRa, or cellular networks. In addition, communication interface 610 may enable command reception from remote devices (e.g., remote computing device 616), sensor data transmission, and communication with other railway vehicles or infrastructure. Wireless communication 618 represents any type of wireless communication that can be used by computing system 604 to communicate with remote computing device 616 and/or other remote systems or devices.

Dump subsystem 612 may include mechanical components and sensors that can be used to automate the release of goods 614 at the designated drop zone. In some instances, dump subsystem 612 may include hydraulic or pneumatic mechanisms, hopper doors, gravity outlets, and release actuators like electric solenoids, controlled by computing systems or remote devices, such as computing system 604 and/or remote computing device 616.

Goods 614, representing the transported cargo, can be transported by railway vehicle 602 and have its weight estimated by system 600 for cargo management, safety, and regulatory compliance. Railway vehicle 602 may be a versatile cargo carrier and can transport a wide variety of goods 614, ranging from bulk commodities to specialized equipment. For example, goods 614 may be bulk commodities, such as coal and other minerals, grain and other agricultural products, sand and aggregates, cement and other construction materials, and chemicals and fertilizers. In some cases, goods 614 may be manufactured goods or consumer goods. Similarly, goods 614 can also be energy products, specialized cargo, waste and recyclables, among other potential options. Goods 614 can depend on the configuration of railway vehicle 602 as well as the type of dump subsystem 612 equipped on railway vehicle 602.

Remote computing device 616 is able to communicate with computing system 604 and may represent any type of processing device or network of processing devices that is located remote from railway vehicle 602. For instance, remote computing device 616 may be a network of computing systems, which may include one or multiple specialized types of processors. In some cases, remote computing device 616 may include one or more servers for machine learning or training models. For instance, remote computing device 616 may include multiple high performance graphics processing units (GPUs), tensor processing units (TPUs), and/or other types of processing units to accelerate training and learning techniques. Specialized processors can be used to perform parallel processing for training machine learning algorithms.

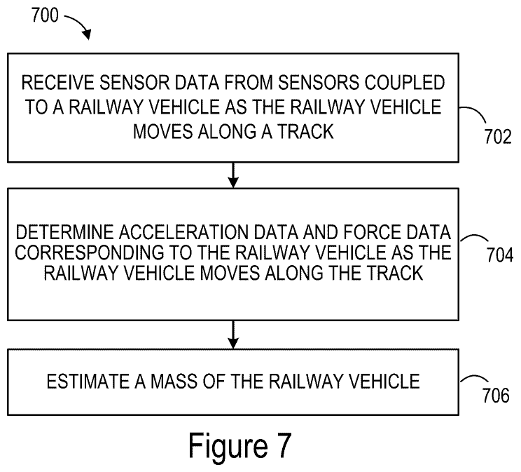

FIG. 7 is a flowchart of a method for estimating the mass of a railway vehicle. Method 700 represents an example method that may include one or more operations, functions, or actions, as depicted by one or more of blocks 702, 704, and 706, each of which may be carried out by any of the systems, devices, and/or vehicles shown in FIGS. 1-6, among other possible systems.

Those skilled in the art will understand that the flowcharts described herein illustrate functionality and operations of certain implementations of the present disclosure. In this regard, each block of the various flowcharts may represent a module, a segment, or a portion of program code, which includes one or more instructions executable by one or more processors for implementing specific logical functions or steps in the process. The program code may be stored on any type of computer readable medium, for example, such as a storage device including a disk or hard drive or loaded into computer memory as in Memory 204.

In addition, each block may represent circuitry that is wired to perform the specific logical functions in the process. Alternative implementations are included within the scope of the example implementations of the present application in which functions may be executed out of order from that shown or discussed, including substantially concurrent or in reverse order, depending on the functionality involved, as may be understood by those reasonably skilled in the art.

At block 702, method 700 involves receiving sensor data from a plurality of sensors coupled to a railway vehicle as the railway vehicle moves along a track. For example, a computing system onboard the railway vehicle may receive first sensor data from an inertial measurement unit coupled to the railway vehicle and second sensor data from a torque sensor representing a torque output by a motor coupled to the railway vehicle. The computing system may then determine, based on the first sensor data, the acceleration of the railway vehicle and also determine, based on the second sensor data, a force applied to the railway vehicle.

At block 704, method 700 involves generating, based on the sensor data, a profile for the railway vehicle that represents an acceleration of the railway vehicle and force applied to the railway vehicle during movement along the track.

At block 706, method 700 involves estimating, based on the profile for the railway vehicle, a mass of the railway vehicle.

In some embodiments, the method may further include adjusting the operation of the communication system based on the estimated mass of the railway vehicle. The adjustment may involve changing the communication protocols, adjusting the data transmission rate, or modifying other operating parameters of the communication system.

In some cases, the method may further include adjusting the operation of the power system based on the estimated mass of the railway vehicle. The adjustment may involve changing the power output, adjusting the energy consumption, or modifying other operating parameters of the power system. In some embodiments, the method may further include adjusting the operation of the control system based on the estimated mass of the railway vehicle. The adjustment may involve changing the control algorithms, adjusting the control parameters, or modifying other operating parameters of the control system.

In some cases, the method may further include adjusting the operation of the sensor system based on the estimated mass of the railway vehicle. The adjustment may involve changing the sensor configuration, adjusting the sensor sensitivity, or modifying other operating parameters of the sensor system. In some embodiments, the method may further include adjusting the operation of the railway vehicle based on the estimated mass of the railway vehicle. The adjustment may involve changing the speed of the railway vehicle, adjusting the trajectory of the railway vehicle, or modifying other operating parameters of the railway vehicle.

In some embodiments, the process of generating a profile for the railway vehicle based on the sensor data involves analyzing the sensor data to determine the acceleration and force applied to the railway vehicle as it moves along the track. The sensor data may be collected from a variety of sensors, such as accelerometers, gyroscopes, and force sensors, among others. These sensors may be strategically positioned on the railway vehicle to capture relevant data. For instance, accelerometers and gyroscopes may be used to measure the acceleration of the railway vehicle, while force sensors may be used to measure the force applied by the motor or the external environment. The computing system may process the sensor data to generate a profile that represents the acceleration and force applied to the railway vehicle during movement along the track. This profile may be generated by analyzing the sensor data over time and identifying patterns or trends in the acceleration and force data. The profile may include information such as the average acceleration and force applied to the railway vehicle, the maximum and minimum values, and the variability or changes in these values over time.

In some embodiments, a particle filter algorithm may be used instead of or in addition to the Kalman filter for processing the sensor data and generating the profile for the railway vehicle. The particle filter is a sequential Monte Carlo method that can handle non-linearities and non-Gaussian noise in the sensor data. The particle filter can provide a more accurate and robust estimation of the state of the system, especially in complex or uncertain environments. The use of a particle filter can enhance the accuracy and reliability of the mass estimation system, particularly in challenging conditions such as variable wind speed and direction, uneven track surfaces, or changes in the load of the railway vehicle.

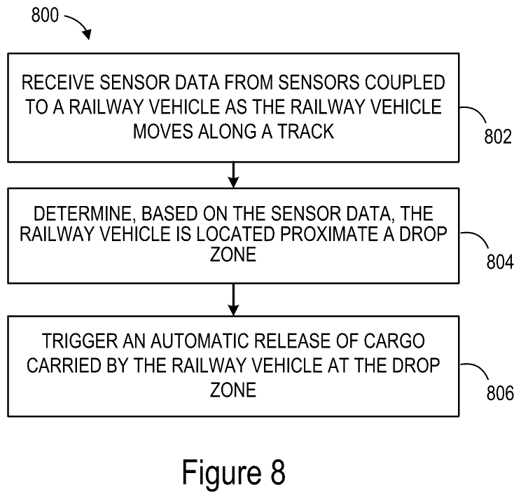

FIG. 8 is a flowchart of a method for deploying cargo carried by a railway vehicle. Method 800 represents an example method that may include one or more operations, functions, or actions, as depicted by one or more of blocks 802, 804, and 806, each of which may be carried out by any of the systems, devices, and/or railway vehicles shown in FIGS. 1-6, among other possible systems.

At block 802, method 800 involves receiving sensor data from sensors coupled to a railway vehicle as the railway vehicle moves along a track. To accurately localize a railway vehicle relative to a drop zone, a combination of sensors and technologies can be used to ensure precision and reliability.

In some examples, sensors are incorporated into the design of railway vehicles during the manufacturing process to enhance functionality, safety, and operational efficiency. For instance, modern railway vehicles may be designed with built-in provisions for various sensors, ensuring seamless integration and optimized performance. In other examples, sensors and other corresponding systems can be retrofitted onto existing railway vehicles. For example, an older freight car can be retrofitted with adapters and/or other components that attach sensors and other components that can be used to enhance performance of the freight car.

Some example sensors are described here, but other sensors may also be used within examples. In some cases, the railway vehicle may include one or multiple cameras, which can be used for both security and operational purposes. For instance, cameras can be strategically placed to provide a 360-degree view around the railway vehicle and can enable real-time monitoring and recording. Cameras positioned along the exterior can help with monitoring the track and surrounding environment while interior cameras can be used to monitor cargo, passengers, or operations of the railway vehicle. The railway vehicle may also use LiDAR and/or radar. LiDAR can use laser beams to measure the distance to surrounding objects, creating a detailed 3D map of the environment. Similarly, radar offers robustness and can be used to detect objects at long distances, regardless of weather conditions. IMUs, GPS, and other types of sensors can also be used.

At block 804, method 800 involves determining, based on the sensor data, the railway vehicle is located proximate a drop zone. The techniques and quantity of sensors used to localize the railway vehicle relative to the drop zone can differ within examples.

In some examples, GPS can be used to pinpoint the geographical coordinates of the railway vehicle, which can then be compared to the known coordinates of the drop zone to determine the railway vehicle's location with respect to it. In some cases, RFID tags or devices may be strategically placed along the railway track, enabling a RFID reader on the railway vehicle to scan the tags or devices as the railway vehicle passes by them. Each RFID tag or device can correspond to a specific location on the track, and when the railway vehicle detects the tag or device positioned nearest to the drop zone, the computing system can ascertain its proximity to the intended unloading point. RFID technology can be used for fine-tuning the railway vehicle's position as it approaches the drop zone.

In some cases, wheel rotation sensors may be used for railway vehicle localization relative to a drop zone or another target location. The wheel rotation sensors may be used to count the number of rotations the wheels make from a known starting point, allowing the onboard computing system to calculate the distance traveled. When calibrated with the layout of the railway track, the data generated using wheel rotation sensors can be used when estimating the current position of the railway vehicle. Wheel rotation sensors may be used in combination with other sensors in some examples.

IMUs can also be used to measure the railway vehicle's acceleration and changes in orientation. A computing system may use data from one or more IMUs for determining location of the railway vehicle. For instance, the computing system may use sensor data from the IMUs to detect subtle movements and/or for localization in environments where GPS signals might be weak or obstructed, such as in tunnels or covered areas. The data from IMUs can be integrated with GPS and other sensor data to refine the railway vehicle's estimated position and ensure accurate localization relative to the drop zone.

In some examples, other types of sensors can be used. For instance, cameras and/or other optical sensors can be used to recognize trackside markers or signage or other landmarks that indicate how close the railway vehicle is to the drop zone. The visual cues can be processed using image recognition algorithms to assist in pinpointing the railway vehicle's location. Additionally, track circuits, which are electrical circuits embedded in the railway infrastructure, can be used to detect the presence of the railway vehicle on a particular section of the track, providing another layer of location data that can be used by the computing system. Similarly, beacons installed along the track can emit signals that may be detected by receivers on the railway vehicle. The computing system may use the timing and strength of these signals to determine the railway vehicle's distance from each beacon, which can then be used to gauge how close the railway vehicle is to the drop zone. For instance, the railway vehicle may use beacons in conjunction with GPS and RFID technologies to ensure that the railway vehicle stops precisely at the designated unloading area.

By integrating data from one or multiple types of sensors, railway vehicles can accurately determine their location relative to drop zones, facilitating efficient and automated cargo unloading processes described herein. In some cases, a sensor fusion approach is used by a railway vehicle to compensate for the limitations of individual sensors and provide redundancy that can improve the overall reliability and safety of the localization system.

At block 806, method 800 involves triggering an automatic release of cargo carried by the railway vehicle at the drop zone. Various techniques can be used to offload cargo at the drop zone. The particular technique used by a railway vehicle can depend on the configuration of the railway vehicle. In addition, the type of cargo can differ. As such, the computing system may factor the type of cargo when triggering the automatic release of the cargo.

In some examples, the railway vehicle is a hopper car or another type of railway vehicle with bottom discharge gates. When the railway vehicle arrives at the target unloading site, the railway vehicle may be positioned over a drop zone, which can include a pit or conveyor system configured to receive the cargo from the railway vehicle. As such, the computing system can trigger an automatic process that opens the bottom discharge gates to deploy the carried goods. For instance, the computing system may modify a state of an electric solenoid coupled to the railway vehicle to cause the railway vehicle to deploy the cargo at the drop zone. The position of the railway vehicle's bottom discharge gate may depend on the state of the electric solenoid.

In some cases, the dump subsystem is controlled by an onboard computing system that uses sensor data to pinpoint when the railway vehicle is located at the drop zone. This process can be performed in an autonomous manner without reliance on operator input. For instance, the sensor measurements can inform a control system that the railway vehicle is positioned at the desired drop zone and responsively trigger the dump subsystem to deploy the carried cargo. In other cases, the dump subsystem may be actuated based on commands received from a remote computing device. For example, the onboard system may communicate a signal to the remote computing device that indicates the railway vehicle is approaching or positioned at the drop zone, which may then enable the remote computing device to approve the deployment of cargo carried by the railway vehicle at the drop zone. The remote computing device may generate a natural language question that enables an operator to review and approve the deployment at the drop zone. For instance, the natural language can specify that the railway vehicle is located at the drop zone and request approval to initiate deployment from the operator who is reviewing the situation.

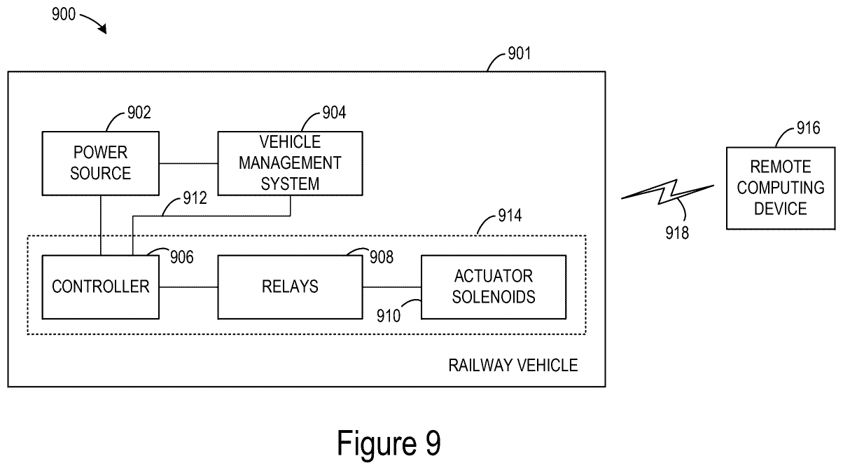

FIG. 9 illustrates a block diagram of system 900 for enabling automatic or remote dumping of materials by railway vehicle 901. In the example, system 900 includes power source 902, vehicle management system 904, controller 906, relays 908, and actuator solenoids 910 positioned on railway vehicle 901. In addition, railway vehicle 901 is shown communicating with remote computing device 916 via communication link 918. In some cases, controller 906, relays 908, and actuator solenoids 910 are part of integrated subsystem onboard railway vehicle 901. In other examples, system 900 may include more or fewer components.

Power source 902 may provide electrical energy to operate the various systems and subsystems of railway vehicle 901, including those involved in the automatic or remote-controlled dumping of cargo at a dump site. In some cases, power source 902 can be a dedicated onboard battery, a generator, or an external power supply that is connected to the railway vehicle when it is stationary. In some aspects, power source 902 may supply energy to vehicle management system 904, controller 906, and/or other components such as relays 908 and actuator solenoids 910. Controller 906 may use the power to process signals from sensors or remote commands received via communication link 918 from remote computing device 916.

For automatic or remote-controlled dumping of cargo, power source 902 may be used in various ways. In particular, power from power source 902 can enable controller 906 to remain operational and responsive to input signals that indicate when railway vehicle 901 has reached a designated dump site. Controller 906, powered by power source 902, may receive signals from remote computing device 916 or onboard sensors that indicate the appropriate time and location to initiate the dumping process. In addition, controller 906, upon determining that the conditions for dumping have been met, may send a signal to activate relays 908 and actuator solenoids 910, which can also be powered by power source 902. These components work together to operate the mechanical parts of the railcar dump system, such as opening gates or tilting the railcar to release the cargo.

For remote-controlled operations, power source 902 may also supply power to communication components, enabling railway vehicle 901 to receive commands from a remote operator to initiate dumping. Power from power source 902 may be used to operate safety systems that ensure the dumping process does not occur prematurely or without proper authorization. It may also power monitoring systems that confirm the successful completion of the dumping process. In some cases, power source 902 may be designed to provide sufficient energy to perform multiple dumping operations without the immediate need for recharging or refueling, enhancing the efficiency and autonomy of the operations of railway vehicle 901. Additionally, power source 902 may be configured to work in harsh environments and withstand the vibrations and shocks typical of railway operations.

Vehicle management system 904 is linked to controller 906, which in turn is connected to relays 908 and actuator solenoids 910. Vehicle management system 904 can serve as the central hub for coordinating the electronic components and subsystems within railway vehicle 901. For instance, vehicle management system 904 may be tasked with the integration of data from various onboard sensors, such as those indicating the location and speed of railway vehicle 901, to make informed decisions about the timing and location for the automatic or remote-controlled dumping of cargo. Additionally, vehicle management system 904 may be responsible for executing the commands that initiate the dumping process, which involves controlling relays 908 and actuator solenoids 910 that release the cargo.

In addition, communication management is another function that may be performed by vehicle management system 904. For instance, vehicle management system 904 may oversee the exchange of information between railway vehicle 901 and external entities, such as a central control station (e.g., remote computing device 916), through the communication link 918. This includes the reception of remote commands for the dumping operation and the transmission of updates regarding the status of the dumping process. To ensure the safety and reliability of the dumping operation, vehicle management system 904 may use strict safety protocols and perform continuous system monitoring. For instance, vehicle management system 904 may verify the position and readiness of railway vehicle 901 before allowing the dumping process to proceed, and it manages the power distribution from the power source 902 to maintain energy efficiency and system functionality. In some cases, vehicle management system 904 may also offer diagnostic capabilities to ensure the railcar dump system is operational and an interface for operators to interact with system 900. Vehicle management system 904 may provide manual controls for initiating or overriding the dumping process and for monitoring system status. Furthermore, vehicle management system 904 may be designed to be modular and scalable, allowing for future technological integrations and autonomous operations with limited human intervention.

As shown in FIG. 9, controller 906 may function as the primary computational and decision-making unit within system 900. For instance, controller 906 may process inputs from various sensors and systems, executing control algorithms, and sending appropriate commands to relays 908 and actuator solenoids 910 to carry out specific actions, such as the dumping of cargo. In addition, controller 906 may also receive and process signals from the vehicle management system 904, which could include data regarding the location, speed, and the status of onboard systems of railway vehicle 901. Based on this information, controller 906 can determine the precise timing for initiating the dumping process when railway vehicle 901 is at the designated dump site. Additionally, controller 906 may handle communication with remote computing device 916 via communication link 918. This allows controller 906 to receive remote commands for dumping operations and to send feedback or status updates after the completion of such operations. In some aspects, controller 906 may also be involved in implementing safety checks and protocols to ensure that the dumping operation is conducted safely and at the correct location. For instance, controller 906 may monitor the system's readiness and the integrity of the connections to relays 908 and actuator solenoids 910, ensuring that all components are functioning correctly before and during the dumping process.

Relays 908 are electrically operated switches that can open or close circuits within system 900. In some cases, relays 908 are used to control the high-power circuits with a low-power signal, allowing controller 906 to safely manage the operation of various systems without being exposed to high voltage or current. Relays 908 can be used to activate or deactivate components or subsystems within the railway vehicle, such as the mechanisms involved in the dumping process.

Actuator solenoids 910 are devices that convert electrical energy into mechanical motion. When an electrical current is passed through the coil of the solenoid, a magnetic field is generated, which then moves a plunger or armature. This movement can be used to mechanically actuate a switch, valve, or other mechanical devices. In the context of system 900, actuator solenoids 910 may be used to physically initiate the cargo dumping mechanism, such as by opening gates or triggering levers that release the cargo. In operation, controller 906 sends signals to relays 908, which in turn control the power supplied to the actuator solenoids 910. When controller 906 or another computing system determines that conditions are right for dumping, controller 906 may activate the appropriate relays. For instance, controller 906 may activate relays 908 based on inputs from vehicle management system 904 or remote commands. Relays 908 can then energize actuator solenoids 910, which perform the physical actions required to dump the cargo from the railway vehicle.

Connections 912 between components within system 900 may be implemented using various types of wired or wireless communication technologies, such as to facilitate the transfer of power and data between power source 902 and controller 906. In some aspects, an Ethernet connection can be employed, which provides a reliable and high-speed data link capable of supporting the communication requirements of the railway vehicle system 900. Ethernet is particularly useful for systems that require a robust network infrastructure, offering advantages such as low latency and high bandwidth.

In addition to Ethernet, connections 912 may also be established using other wired communication standards such as Controller Area Network (CAN), Serial, USB, or any other suitable protocol that meets the system's requirements for data integrity, speed, and connectivity. These wired connections ensure a secure and direct link for the transmission of power and data signals. Furthermore, connections 912 may also be configured to utilize wireless communication technologies. This could include Wi-Fi, Bluetooth, Zigbee, or cellular networks, which can provide the flexibility of remote connectivity without the constraints of physical wiring. Wireless connections can be advantageous in dynamic environments where system 900 may require remote access or when system 900 is designed to be modular and easily reconfigurable.

Regardless of the type of connection, the power source to controller connection may be designed to ensure a reliable and continuous flow of power and data between power source 902 and controller 906. This allows the controller to perform its functions effectively, including managing relays 908 and actuator solenoids 910, and communicating with vehicle management system 904 and remote computing device 916. The choice of connection technology may be influenced by factors such as the specific application, environmental conditions, and the desired balance between reliability, speed, and installation costs.

Additionally, railway vehicle 901 may communicate with remote computing device 916 through communication link 918 using various communication protocols and technologies to enable the exchange of data and control commands. Communication link 918 may be established using wired or wireless methods, depending on the requirements of system 900 and the operational environment.

In some cases, communication link 918 may utilize wireless communication technologies such as Wi-Fi, cellular networks (e.g., LTE, 5G), satellite communication, or dedicated radio frequencies. These wireless methods allow for remote monitoring and control of system 900 from remote computing device 916, which could be located at a central control station or operated by field personnel using portable devices. Alternatively, communication link 918 may be implemented using wired connections, such as Ethernet, fiber optics, or other suitable cabling, which can provide a high-speed and secure data link between system 900 and remote computing device 916. Wired connections are often used in environments where wireless communication may be unreliable or where high data throughput is a priority. Communication link 918 may support various data transmission standards and protocols to ensure compatibility and interoperability with remote computing device 916. These may include TCP/IP for network communications, MQTT for lightweight messaging, or other application-specific protocols designed for railway operations.

Through communication link 918, remote computing device 916 may send commands to controller 906 to initiate actions such as starting or stopping the dumping process, adjusting operational parameters, or requesting status updates. Conversely, controller 906 may transmit data to remote computing device 916, such as system status, alerts, or confirmation of actions taken. This bidirectional communication enables centralized management of the railway vehicle system 900 and enhances the ability to perform remote diagnostics and maintenance. Remote computing device 916 may serve as a user interface for system 900, providing a platform for users to interact with railway vehicle 901, monitor its status, and issue commands. As a user controller, remote computing device 916 may be equipped with software that displays a graphical user interface (GUI) or a command-line interface (CLI) through which the user can engage with the system. In this capacity, remote computing device 916 may present a list of available devices within system 900, such as individual railcars equipped with the railcar dump system. This list can be dynamically updated to reflect the current status and availability of each device, including whether they are ready for dumping, currently in operation, or in a fault state.

The user interface on remote computing device 916 may allow users to select one or more devices from the displayed list and send dump commands to initiate the dumping process. The interface could provide options for single or batch operations, where a user can command multiple railcars to dump their cargo sequentially or simultaneously, depending on operational requirements. To send a dump command, the user may interact with the GUI by clicking on a button or entering a command through the CLI (e.g., voice control). Remote computing device 916 then communicates the command to railway vehicle 901 via communication link 918. Controller 906 may receive the command and process it, activating the appropriate relays 908 and actuator solenoids 910 to execute the dumping operation. Additionally, remote computing device 916 may provide feedback to the user after a command is sent, such as a confirmation message or a progress update. It may also display real-time data from sensors or logs, allowing the user to monitor the operation as it occurs and to verify that the dump command has been successfully executed.

Remote computing device 916 can be implemented on various hardware platforms, including desktop computers, laptops, wearable computing devices, tablets, or smartphones, and may be located on-site or remotely, offering flexibility and convenience to the user. The software used by remote computing device 916 may also include security features such as authentication and encryption to ensure that commands are issued by authorized personnel and that communication with railway vehicle 901 is secure.

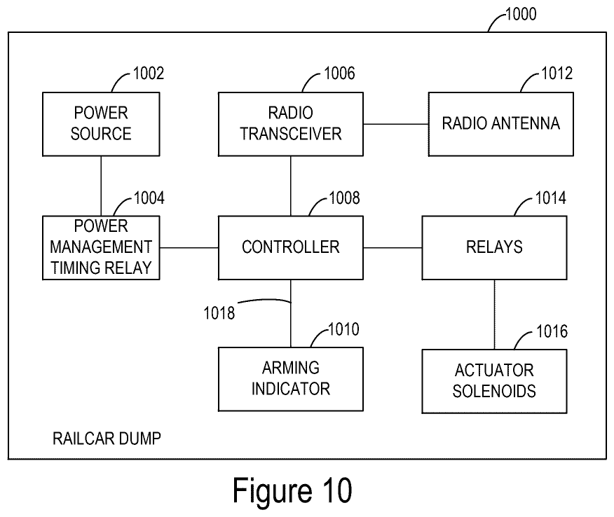

FIG. 10 depicts a block diagram of railcar dump system 1000. In the example, system 1000 includes power source 1002, power management timing relay 1004, radio transceiver 1006, controller 1008, arming indicator 1010, radio antenna 1012, relays 1014, and actuator solenoids 1016. These components may be connected in various ways via connection mechanisms 1018, which can represent various types of connection technologies. Railcar dump system 1000 can be positioned on various types of railway vehicles, such as freight railcars.

Similar to power source 902 shown in FIG. 9, power source 1002 supplies energy to railcar dump system 1000, which is managed by power management timing relay 1004. Radio transceiver 1006 may communicate with radio antenna 1012 to facilitate wireless control. Controller 1008 may be used to orchestrate the overall operation, receiving inputs from power management timing relay 1004 and radio transceiver 1006. Arming indicator 1010 provides a visual status of the readiness of railcar dump system 1000. Relays 1014, controlled by controller 1008, may activate actuator solenoids 1016 to perform the dumping operation.

Power source 1002 may be used to provide the electrical energy for operations by components of railcar dump system 1000. Similar to power source 902, power source 1002 may be implemented using various types of energy storage or generation devices, such as batteries, capacitors, solar panels, the railcar's power source, or a connection to an external power grid. In some aspects, power source 1002 may be designed to ensure a stable and continuous supply of power, accommodating the energy demands of railcar dump system 1000 during the dumping process. For example, a railcar dump system might utilize a rechargeable battery pack that provides sufficient capacity to operate the system autonomously for multiple dump cycles.

In addition to supplying power, power source 1002 may also incorporate features such as voltage regulation, surge protection, and power conditioning to maintain the quality of the electrical supply to the components of railcar dump system 1000. This is particularly beneficial in environments where the power source may be subject to fluctuations or disturbances. For instance, a railcar dump system operating in a remote mining operation might employ a solar panel array coupled with a battery bank, ensuring that the system can function reliably even in the absence of a traditional power grid.

Power management timing relay 1004 may be used to manage the distribution and timing of power within railcar dump system 1000. For instance, power management timing relay 1004 may function to sequence the activation of system components, thereby optimizing the power usage and preventing overloads. The timing relay can be programmed to delay the energization of specific components, such as actuator solenoids 1016, until the appropriate moment in the dumping cycle. For example, a timing relay might be configured to activate the actuator solenoids after a predetermined interval following the receipt of a dump command, ensuring synchronized operation.

Furthermore, power management timing relay 1004 may monitor the power consumption of railcar dump system 1000 and provide diagnostic information related to the electrical performance. This can include features such as current sensing, voltage monitoring, and the detection of circuit anomalies. In some cases, power management timing relay 1004 may be used to detect a fault condition, such as an open circuit or short circuit, and trigger a safety shutdown to prevent damage to railcar dump system 1000.

Radio transceiver 1006 may serve as the wireless communication hub of railcar dump system 1000, enabling the exchange of data and commands between the system and remote operators or automated control systems. It may support various wireless communication standards, such as Wi-Fi, Bluetooth, or proprietary radio frequencies, depending on the operational range, data throughput, and reliability requirements. For instance, railcar dump system 1000 may use a long-range radio transceiver to maintain connectivity with a remote control center over distances where Wi-Fi signals are insufficient. Radio transceiver 1006 may also be used to provide secure and reliable communication. It may implement encryption and error-correction protocols to protect the integrity of the transmitted data. In an example scenario, railcar dump system 1000 could use encrypted signals to prevent unauthorized access and ensure that dump commands are received and executed without interference.

Controller 1008 may act as the central processing unit of railcar dump system 1000, interpreting input signals, making decisions based on programmed logic, and issuing commands to the various components of railcar dump system 1000. In some cases, controller 1008 may be a microcontroller, programmable logic controller (PLC), or any other suitable computing device capable of executing the control algorithms. For example, a PLC might be used in a railcar dump system to provide robust and real-time control over the dumping process, handling tasks such as timing, sequencing, and safety interlocks.

Controller 1008 may also be responsible for interfacing with other system components, such as power management timing relay 1004 and radio transceiver 1006, to coordinate the overall operation. Controller 1008 can process inputs from sensors, user commands, and other external signals to adapt the behavior of railcar dump system 1000 dynamically. In some cases, controller 1008 may receive input from a load sensor indicating that a railcar is in position and ready to dump, and then activate actuator solenoids 1016 to initiate the dumping sequence.

Arming indicator 1010 may be used to provide a visual and/or auditory signal indicating the operational status of railcar dump system 1000. For instance, arming indicator 1010 may consist of lights, such as LEDs, that display different colors or patterns to convey the system's readiness or alert operators to specific conditions. For instance, a green light might indicate that railcar dump system 1000 is armed and ready to receive a dump command, while a red light could signal a fault or safety lockout condition.

In addition to serving as a status indicator, arming indicator 1010 can also enhance the safety of railcar dump system 1000 by alerting personnel to potentially hazardous situations. Arming indicator 1010 may be integrated with the system's safety protocols to ensure that it accurately reflects the current state of the system. An example of this could be a railcar dump system where the arming indicator emits an audible alarm when the system is activated, warning nearby workers to clear the area before the dumping process begins.

Radio antenna 1012 is a component of railcar dump system 1000 that can facilitate the transmission and reception of wireless signals by radio transceiver 1006. In some cases, radio antenna 1012 may be designed to optimize signal strength and quality over the operational range of the system. Radio antenna 1012 can be a directional antenna, which focuses the signal in a specific direction for increased range, or an omnidirectional antenna, which broadcasts signals in all directions for ease of connectivity. For example, a directional antenna might be used in railcar dump system 1000 to maintain a strong communication link with a distant control center. Radio antenna 1012 can also be selected based on factors such as frequency band, environmental conditions, and installation constraints. It may include additional features like signal amplification or noise filtering to improve communication reliability. In a practical application, a railcar dump system operating in a harsh industrial environment might use a ruggedized antenna with a protective enclosure to withstand exposure to dust, vibration, and extreme temperatures.

Relays 1014 are electromechanical or solid-state switches within railcar dump system 1000 that control the flow of power to actuator solenoids 1016 and other electrical components. Relays 1014 may be used to isolate the high-power circuits of actuator solenoids 1016 from the low-power control signals from controller 1008. For instance, a railcar dump system might use relays to ensure that the high current demands of the actuator solenoids do not directly impact the controller's delicate circuitry. In addition, relays 1014 can also provide safety features such as circuit protection and fail-safe mechanisms. They may be designed to open or close in response to specific conditions, such as overcurrent or signal loss, to protect the system and ensure safe operation. An example of this could be a railcar dump system where the relays are configured to de-energize the actuator solenoids in the event of a communication disruption, preventing unintended dumping.

Actuator solenoids 1016 are devices within railcar dump system 1000 that can convert electrical energy into mechanical motion to perform the physical action of dumping. As such, actuator solenoids 1016 may be linear or rotary solenoids, depending on the type of movement required for the dumping mechanism. For example, a linear actuator solenoid might be used to unlock a railcar's bottom dump doors, allowing the contents to be discharged by gravity. Actuator solenoids 1016 are activated by electrical signals from controller 1008, which are routed through relays 1014. They are designed to provide the precise force and speed necessary for the dumping operation and may include features such as end-of-travel limit switches or position feedback sensors. In a practical scenario, a railcar dump system may use a set of actuator solenoids to sequentially open and close multiple dump gates, enabling controlled and efficient unloading of bulk materials.

The above detailed description describes various features and functions of the disclosed systems, devices, and methods with reference to the accompanying figures. While various aspects and embodiments have been disclosed herein, other aspects and embodiments will be apparent. The various aspects and embodiments disclosed herein are for purposes of illustration and are not intended to be limiting, with the true scope being indicated by the following claims.

It should be understood that arrangements described herein are for purposes of example only. As such, those skilled in the art will appreciate that other arrangements and other elements (e.g. machines, apparatuses, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

What is claimed is:

1. A method comprising:
receiving, at a computing system, sensor data from a plurality of sensors coupled to a railway vehicle as the railway vehicle moves along a track;
determining, based on the sensor data, acceleration data and force data corresponding to the railway vehicle as the railway vehicle moves along the track, wherein the force data represents a quantity of force applied to railway vehicle to cause the railway vehicle to move along the track; and
estimating, based on the acceleration data and force data for the railway vehicle, a mass of the railway vehicle.

2. The method of claim 1, wherein the plurality of sensors comprises an inertial measurement unit and a torque sensor, and
wherein the inertial measurement unit is configured to measure acceleration of the railway vehicle and the torque sensor is configured to measure a torque output by a motor coupled to the railway vehicle.

3. The method of claim 2, wherein the motor is coupled to an axle of the railway vehicle via a bearing adapter.

4. The method of claim 1, further comprising:
generating a profile corresponding to the railway vehicle, wherein the profile represents at least the acceleration data and force data corresponding to the railway vehicle as the railway vehicle moves along the track and a predefined mass of the railway vehicle, wherein the predefined mass of the railway vehicle represents a weight of the railway vehicle in an empty state.

5. The method of claim 4, further comprising:
processing sensor data from the plurality of sensors using a Kalman filter; and
wherein generating the profile corresponding to the railway vehicle comprises:
generating the profile corresponding to the railway vehicle based on processing the sensor data from the plurality of sensors using the Kalman filter.

6. The method of claim 4, further comprising:
comparing the estimated mass of the railway vehicle to the predefined mass of the railway vehicle to determine a weight of cargo carried by the railway vehicle.

7. The method of claim 1, further comprising:
adjusting a control strategy for the railway vehicle based on the estimated mass of the railway vehicle.

8. The method of claim 1, further comprising:
causing the railway vehicle to move along the track according to a predefined trajectory, wherein the predefined trajectory comprises moving in a first direction along the track for a first distance and subsequently moving in a second direction along the track for a second distance, wherein the second direction is opposite of the first direction; and
wherein determining acceleration data and force data corresponding to the railway vehicle as the railway vehicle moves along the track comprises:
determining an average acceleration of the railway vehicle and an average force applied to the railway vehicle using sensor data obtained as the railway vehicle moved along the track according to the predefined trajectory.

9. The method of claim 1, wherein the railway vehicle is a freight railway vehicle having a motor coupled to an axle.

10. The method of claim 9, further comprising:
determining, based on the sensor data, the railway vehicle is located proximate a drop zone, wherein the drop zone is a target destination for deploying cargo carried by the railway vehicle; and
triggering, based on determining that the railway vehicle is located proximate the drop zone, an automatic release of the cargo carried by the railway vehicle at the drop zone.

11. The method of claim 10, wherein triggering the automatic release of the cargo carried by the railway vehicle comprises:
modifying a state of an electric solenoid coupled to the railway vehicle to cause the railway vehicle to deploy the cargo at the drop zone.

12. The method of claim 11, wherein a position of a bottom discharge gate of the railway vehicle depends on the state of the electric solenoid.

13. The method of claim 10, wherein determining the railway vehicle is located proximate the drop zone comprises:
determining the railway vehicle is located proximate the drop zone based on one or more image data from a camera coupled to the railway vehicle, point cloud data from a LiDAR coupled to the railway vehicle, or data from a radio frequency identification (RFID) device coupled to the railway vehicle.

14. The method of claim 10, further comprising:
based on determining the railway vehicle is located proximate the drop zone, providing a signal to a remote computing device, wherein the signal indicates the railway vehicle is located proximate the drop zone;
receiving a response from the remote computing device; and
triggering the automatic release of the cargo carried by the railway vehicle at the drop zone based on receiving the response from the remote computing device.

15. A system comprising:
a computing device coupled to a railway vehicle, wherein the computing device is configured to:
receive sensor data from a plurality of sensors coupled to the railway vehicle as the railway vehicle moves along a track;
determine, based on the sensor data, acceleration data and force data corresponding to the railway vehicle as the railway vehicle moves along the track, wherein the force data represents a quantity of force applied to the railway vehicle to cause the railway vehicle to move along the track; and
estimate, based on the acceleration data and force data for the railway vehicle, a mass of the railway vehicle.

16. The system of claim 15, further comprising:
a motor coupled to an axle of the railway vehicle via a bearing adapter; and
wherein the computing device is configured to:
determine the force data based on sensor data representing torque generated by the motor as the railway vehicle moves along the track.

17. The system of claim 16, wherein the computing device is further configured to:
adjust one or more control parameters of the motor based on the estimated mass of the railway vehicle.

18. The system of 16, wherein the computing device is further configured to:
compare the estimated mass of the railway vehicle to a predefined mass of the railway vehicle to determine a weight of cargo being carried by the railway vehicle, wherein the predefined mass of the railway vehicle represents a weight of the railway vehicle in an empty state.

19. The system of claim 18, wherein the computing device is further configured to:
communicate the weight of cargo being carried by the railway vehicle to a remote computing device via a wireless network.

20. A non-transitory computer readable medium configured to store instructions, that when executed by a computing system comprising one or more processors, causes the computing system to perform operations comprising:
receiving sensor data from a plurality of sensors coupled to the railway vehicle as the railway vehicle moves along a track;
determining, based on the sensor data, acceleration data and force data corresponding to the railway vehicle as the railway vehicle moves along the track, wherein the force data represents a quantity of force applied to the railway vehicle to cause the railway vehicle to move along the track; and
estimating, based on the acceleration data and force data for the railway vehicle, a mass of the railway vehicle.
